(19) United States
(12) Patent Application Publication
(10) Pub. No.: US 2018/0096249 A1
(43) Pub. Date: Apr. 5, 2018

(54) CONVOLUTIONAL NEURAL NETWORK SYSTEM USING ADAPTIVE PRUNING AND WEIGHT SHARING AND OPERATION METHOD THEREOF

(71) Applicant: ELECTRONICS AND TELECOMMUNICATIONS RESEARCH INSTITUTE, Daejeon (KR)

(72) Inventors: Jin Kyu KIM, Sejong (KR); Joo Hyun LEE, Daejeon (KR)

(21) Appl. No.: 15/718,912

(22) Filed: Sep. 28, 2017

(30) Foreign Application Priority Data
Oct. 4, 2016 (KR) 10-2016-0127854
Mar. 3, 2017 (KR) 10-2017-0027951

(51) Int. Cl. G06N 3/08

(52) U.S. Cl. CPC G06N 3/082

(57) ABSTRACT

Provided is a method for operating a convolutional neural network. The method includes performing learning on weights between neural network nodes by using input data, removing an adaptive parameter that performs learning using the input data after removing a weight having a size less than a threshold value among weights, and mapping remaining weights in the removing of the adaptive parameter to a plurality of representative values.

### CROSS-REFERENCE TO RELATED APPLICATIONS

This U.S. non-provisional patent application claims priority under 35 U.S.C. § 119 of Korean Patent Application Nos. 10-2016-0127854, filed on Oct. 4, 2016, and 10-2017-0027951, filed on Mar. 3, 2017, the entire contents of which are hereby incorporated by reference.

### BACKGROUND

The present disclosure relates to a neural network system, and more particularly to a convolutional neural network system capable of adaptively reducing the number of parameters and an operation method thereof.

Recently, Convolutional Neural Network (CNN), which is one of Deep Neural Network techniques, is actively used as a technology for image recognition. The neural network structure shows excellent performance in various object recognition fields such as object recognition and handwriting recognition. In particular, the CNN provides very effective performance for object recognition.

The number of parameters used in the CNN is very large, and the number of connections between nodes is very large, so a memory size required for an operation should be large. In addition, since the CNN requires a substantially high bandwidth memory, it is not easy to be implemented in embedded systems or mobile systems. In addition, the CNN requires a high computational amount for fast processing, and thus has a disadvantage that the size of an internal operator increases.

Therefore, in order to reduce the computational complexity and the recognition time of a neural network algorithm, a method of reducing the number of parameters used in the neural network system is in desperate need.

### SUMMARY

The present disclosure provides a convolutional neural network system capable of adaptively reducing the number of parameters and an operation method thereof.

An embodiment of the inventive concept provides an operation method of a convolutional neural network. The method includes: performing learning on weights between neural network nodes by using input data; removing an adaptive parameter that performs learning using the input data after removing a weight having a size less than a threshold value among weights; and mapping remaining weights in the removing of the adaptive parameter to a plurality of representative values.

In an embodiment of the inventive concept, a convolutional neural network system includes: an input buffer configured to buffer input data; an operation unit configured to learn a parameter between a plurality of neural network nodes by using the input data; an output buffer configured to store and update a learning result of the operation unit; a parameter buffer configured to deliver a parameter between the plurality of neural network nodes to the operation unit and update the parameter according to a result of the learning; and a control unit configured to control the parameter buffer to remove weights having a size less than a threshold value among weights between the neural network nodes and map remaining weights among the weights to at least one representative value.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram showing a CNN system according to an embodiment of the inventive concept;

FIGS. 2A and 2B are views showing an operation procedure and the number of parameters of a CNN;

FIG. 3 is a flowchart briefly showing an operation method of a CNN for reducing parameters according to an embodiment of the inventive concept;

FIG. 4 is a view schematically showing a method of reducing the parameters of the neural network of the inventive concept described with reference to FIG. 3;

FIG. 5 is a flowchart briefly showing an adaptive parameter removal technique according to an embodiment of the inventive concept;

FIG. 6 is a view showing a probability distribution for each operation of parameters when the adaptive parameter removal technique of FIG. 5 is applied;

FIG. 7 is a view showing an adaptive weight sharing technique according to an embodiment of the inventive concept; and

FIG. 8 is a table showing an example of the effect of the inventive concept.

### DETAILED DESCRIPTION

In general, a convolution operation is an operation for detecting a correlation between two functions. The term “Convolutional Neural Network (CNN)” refers to a process or system for performing a convolution operation with a kernel indicating a specific feature and repeating a result of the operation to determine a pattern of an image.

In the following, embodiments of the inventive concept will be described in detail so that those skilled in the art easily carry out the inventive concept.

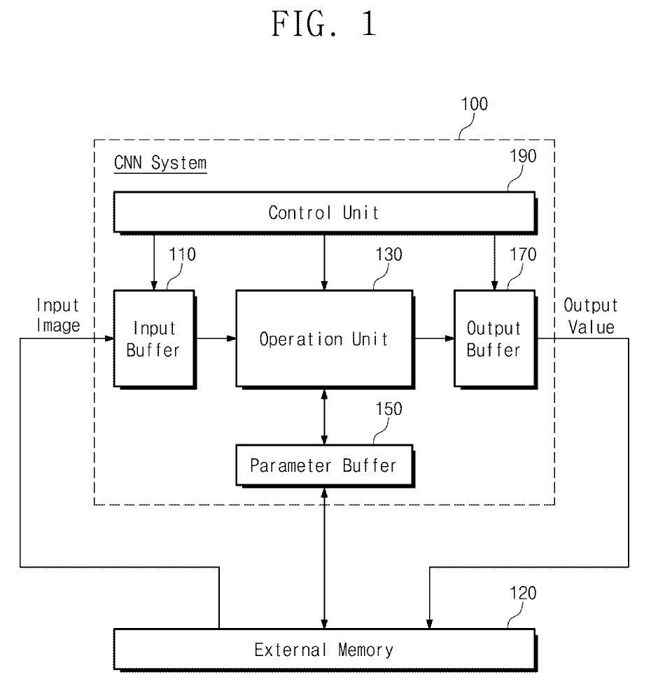

FIG. 1 is a block diagram showing a CNN system according to an embodiment of the inventive concept. Referring to FIG. 1, a CNN system 100 may process an input image provided from an external memory 120 to generate an output value.

The input image may be a still image or a moving image provided through an image sensor. The input image may be an image transmitted through wired/wireless communication means. The input image may represent a two-dimensional array of digitized image data. The input image may be sample images provided for training of the CNN system 100. The output value is the result of processing the input image by the CNN system 100. The output value is a determination result value on an image inputted from the learning operation or the estimation operation of the CNN system 100. The output value may be pattern or identification information included in the input image, which is detected by the CNN system 100.

The CNN system 100 may include an input buffer 110, an operation unit 130, a parameter buffer 150, an output buffer 170, and a control unit 190.

The input buffer 110 is loaded with the data values of the input image. The size of the input buffer 110 may vary depending on the size of a kernel for the convolution operation. For example, when the size of the kernel is K×K, the input buffer 110 should be provided with an input data size sufficient to sequentially perform a convolution operation (or kernelling) with the kernel by the operation unit 130. The loading of the input data into the input buffer 110 may be controlled by the control unit 190.

The operation unit 130 performs a convolution operation or a pooling operation using the input buffer 110, the parameter buffer 150, and the output buffer 170. The operation unit 130 may perform kernelling that iteratively processes multiplication and addition with the kernel for the input image, for example. The operation unit 130 may include parallel processing cores for processing a plurality of kernelling or pooling operations in parallel.

The kernel may be provided from the input buffer 110 or the parameter buffer 150, for example. The process of multiplying all the data of the overlapping position of the kernel with the input image and summing up the results will be referred to as kernelling hereinafter. Each of the kernels may be regarded as a specific feature identifier. This kernelling will be performed on kernels corresponding to the input image and various feature identifiers. The procedure in which such kernelling is performed by various kernels may be performed in a convolution layer, and feature maps corresponding to a plurality of channels may be generated as a result.

The operation unit 130 may process the feature maps generated by the convolution layer with downsampling. Since the size of the feature maps generated by the convolution operation is relatively large, the operation unit 130 may perform a pooling to reduce the size of the feature maps. The result value of each kernelling or pooling operation may stored in the output buffer 170, and may be updated each time the number of convolution loops increases and each time a pooling operation occurs.

The parameter buffer 150 provides parameters necessary for kernelling, bias addition, activation Relu, and pooling performed in the operation unit 130. And the parameters learned in the learning operation may be stored in the parameter buffer 150.

The output buffer 170 is loaded with the result value of kernelling or pooling executed by the operation unit 130. The result value loaded into the output buffer 170 is updated according to the execution result of each convolution loop by the plurality of kernels.

The control unit 190 may control the operation unit 130 to perform a convolution operation, a pooling operation, an activation operation, and the like according to an embodiment of the inventive concept. The control unit 190 may perform a convolution operation using an input image or a feature map and a kernel. The control unit 190 may control the operation unit 130 to perform an adaptive parameter removal operation that removes low weight parameters in the learning operation or the real runtime operation. In addition, the control unit 190 may map the parameters of the same or similar values for each layer to the representative parameters among the remaining weights through the adaptive parameter removal operation. If the same or similar parameters for each layer are shared as representative parameters, the bandwidth requirement amount for exchanging data with the external memory 120 may be greatly reduced.

In the above, the configuration of the CNN system 100 of the inventive concept has been exemplarily described. The number of parameters to be managed by the CNN system 100 may be drastically reduced through the adaptive parameter removal operation and the adaptive parameter sharing operation. The memory size or the bandwidth of a memory channel required to configure the CNN system 100 may be reduced as the number of parameters decreases. And, the reduction of the memory size and the channel bandwidth may improve the hardware implementation possibility of a CNN in a mobile device.

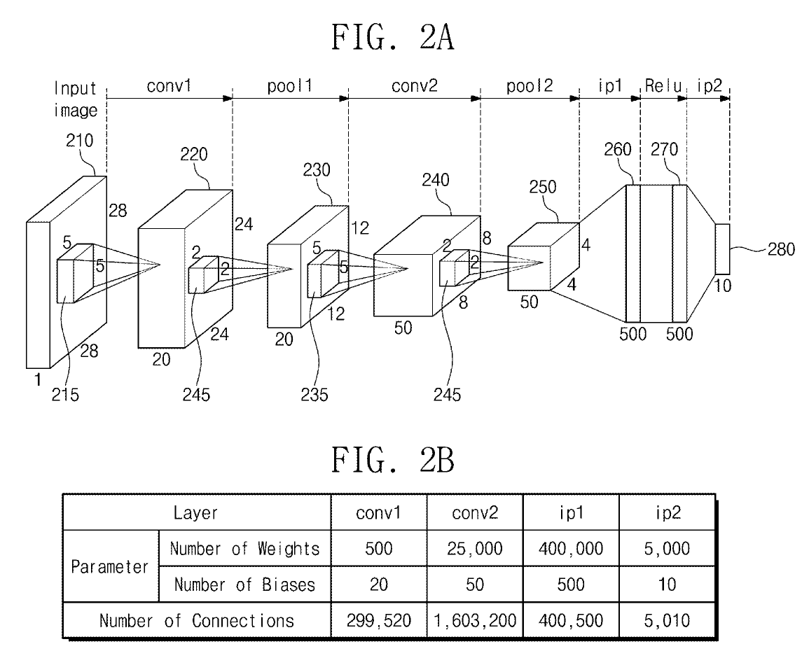

FIGS. 2A and 2B are views showing an operation procedure and the number of parameters of a CNN. FIG. 2A is a view showing layers of a CNN for processing an input image. FIG. 2B is a table showing the number of parameters used for each layer shown in FIG. 2A.

Referring to FIG. 2A, a very large number of parameters are inputted, newly generated, and updated in a convolution operation, a pooling operation, and an activation operation performed in an operation such as learning or object recognition. The input image 210 is processed by a first convolution layer conv1 and a first pooling layer pool 1 for down-sampling the result. When the input image 210 is provided, the first convolution layer conv1, which performs a convolution operation with the kernel 215, is applied first. That is, the data of the input image 210 overlapping with the kernel 215 is multiplied with the data defined in the kernel 215. And all the multiplied values will be summed and generated as one feature value to configure a point of the first feature map 220. Such a kernelling operation will be repeatedly performed as the kernel 215 is sequentially shifted.

A kernelling operation for one input image 210 is performed for a plurality of kernels. And the first feature map 220 in the form of an array corresponding to each of the plurality of channels may be generated according to the application of the first convolution layer conv1. For example, when four kernels are used, the first feature map 220 configured using four arrays or channels may be generated. However, when the input image 210 is a three-dimensional image, the number of feature maps increases sharply, and the depth, which is the number of repetitions of a convolution loop, may also rapidly increase.

Subsequently, down-sampling is performed to reduce the size of the first feature map 220 when execution of the first convolution layer conv1 is completed. The data of the first feature map 220 may be a size that is burdensome to processing depending on the number of kernels or the size of the input image 210. Therefore, in the first pooling layer pool 1, downsampling (or sub-sampling) is performed to reduce the size of the first feature map 220 within a range that does not significantly affect the operation result. A typical operation method of downsampling is pooling. A maximum value or an average value in a corresponding area may be selected while a filter for downsampling is slid with a predetermined stride in the first feature map 220. The case where the maximum value is selected is called a maximum pooling, and the method of outputting an average value is called an average pooling. The first feature map 220 is generated into a size-reduced second feature map 230 by the pooling layer pool1.

The convolution layer in which the convolution operation is performed and the pooling layer in which the downsampling operation is performed may be repeated as necessary. That is, as shown in the drawing, a second convolution layer conv2 and a second pooling layer pool2 may be performed. A third feature map 240 may be generated through the second convolution layer conv2 and a fourth feature map 250 may be generated by the second pooling layer pool2. Then, the fourth feature map 250 is generated into fully connected layers 260 and 270 and an output layer 280 through fully connected network operations ip1 and ip2 and an activation layer Relu. In the fully connected network operations ip1 and ip2 and the activation layer Relu, the kernel is not used. Of course, although not shown in the drawing, a bias addition or activation operation may be added between the convolution layer and the pooling layer.

Referring to FIGS. 2A and 2B, when an input image having a size of 28×28 pixels is inputted, a convolution operation using a kernel 215 of a 5×5 size is performed in the first convolution layer conv1. Since the convolution operation is performed without padding at the edge portion of the input image, the first feature map 220 having a 24×24 size of 20 output channels is outputted. The number of output channels, i.e., 20, is the number of channels determined by the number of kernels, i.e., 215, used in the first convolution layer conv1. And, the bias is a value added between the respective channels and corresponds to the number of channels.

In the above condition, the number of parameters (or the number of weights) used in the first convolutional layer conv1 is a value, i.e., 500, obtained by multiplying the number of output channels, i.e., 20, the number of input channels, i.e., 1, and the size of the kernel, i.e., 5×5. Also, the number of connections in the first convolution layer conv1 is generated by a value, i.e., 299,520, obtained by multiplying the output size of the first feature map, i.e., 24×24, and the number of parameters, i.e., 500+20. In the first pooling layer pool 1, the width and height of the channel are adjusted while maintaining the number of channels in the spatial domain. The pooling operation has the effect of approximating the feature data of an image in a spatial domain.

The operation of each of the second convolution layer conv2 and the second pooling layer pool2 is the same as that of the first convolution layer conv1 and the first pooling layer pool1 except that the number of channels and the kernel size are different. The number of parameters (or the number of weights) used in the second convolutional layer conv2 is a value, i.e., 25000, obtained by multiplying the number of output channels, i.e., 50, the number of input channels, i.e., 20, and the size of the kernel, i.e., 5×5. Also, the number of connections in the second convolution layer conv2 is generated by a value, i.e., 1,603,200, obtained by multiplying the size of the third feature map, i.e., 8×8, and the number of parameters, i.e., 25000+50.

The fully connected layers ip1 and ip2 performs a Fully Connected Networks (FCN) operation. In the FCN operation, the kernel is not used. All input nodes and all output nodes maintain all connection relationships. Thus, the number of parameters, i.e., 400 or 500, in the first fully connected layer ip1 is considerably greater.

In the inventive concept, as shown in FIGS. 2A and 2B, if the number of parameters to be used is reduced, the number of connections may be reduced naturally, and thus the operation amount may be reduced. In addition, the parameters may be divided into a weight and a bias. Since the number of biases is relatively small, a weight reduction method may be used to provide a high compression effect.

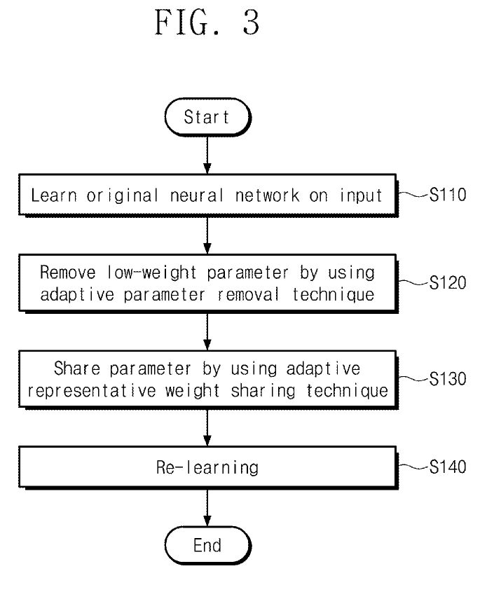

FIG. 3 is a flowchart briefly showing an operation method of a CNN for reducing parameters according to an embodiment of the inventive concept. Referring to FIG. 3, the operation method of the inventive concept may provide a high parameter reduction effect by applying an operation for removing a low weight parameter and a weight sharing technique.

In operation S110, the original neural network learning for input is performed. That is, neural networks are learned by using inputs in a state where all nodes exist. Then, the learned parameters for all connections between nodes may be obtained. When the distribution of the learned parameters is examined in this state, it is similar to the normal distribution.

In operation S120, an adaptive parameter removal technique for the learned neural network parameters is applied. The adaptive parameter removal technique has three operations. In the first operation, an initial threshold value is calculated for every layer of a neural network. Then, in the subsequent second operation, parameters are gradually removed as iterative learning progresses starting from the initial threshold value calculated in the first operation. If the parameter is continuously removed through iterative learning, no parameter lower than the threshold value is generated at some point. At this point, it proceeds to the third operation. In the third operation, the threshold value is adjusted upward to further increase the neural network compression efficiency. When the second and third operations are repeatedly used, the parameters with a low weight are learned while being smoothly removed. Therefore, only the necessary parameters are finally present in the neural network.

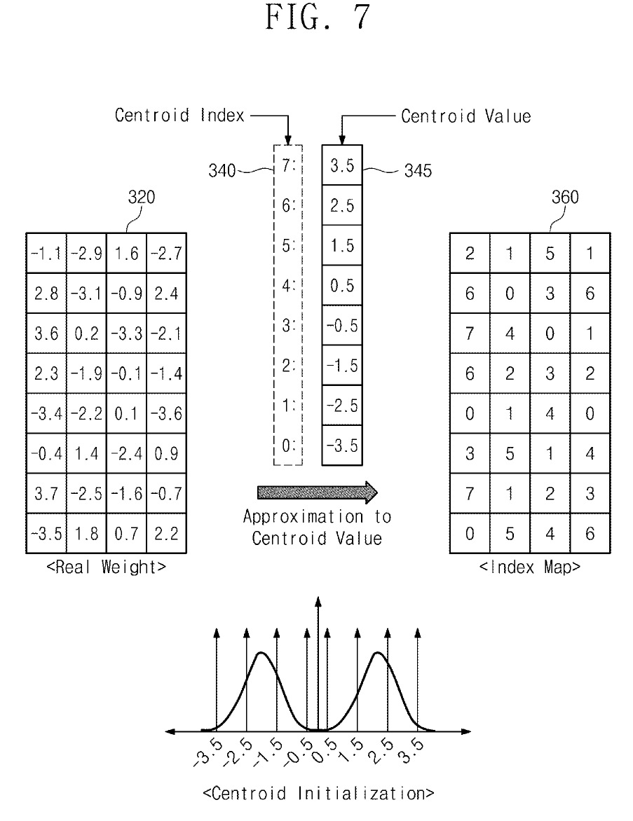

In operation S130, an adaptive representative weight sharing technique for low weight removed parameters is applied. The adaptive representative weight sharing technique is a method of mapping the same or similar parameters into parameters having a single representative value and sharing them. The parameter sharing technique will be described in detail with reference to FIG. 7.

In operation S140, the neural network of the parameters processed by the adaptive representative weight sharing technique is re-learned. By re-learning, the representative weight of the neural network may be fine-tuned to have high accuracy.

The learning process of the neural network using the adaptive parameter removal technique and the adaptive representative weight sharing technique according to an embodiment of the inventive concept is described above. When the adaptive parameter removal technique and the adaptive representative weight sharing technique are used, the number of parameters required for the neural network may be drastically reduced. And the complexity and computational amount of the neural network operation are reduced as the number of parameters decreases. Thus, the size and bandwidth of a memory required for a neural network operation may be greatly reduced.

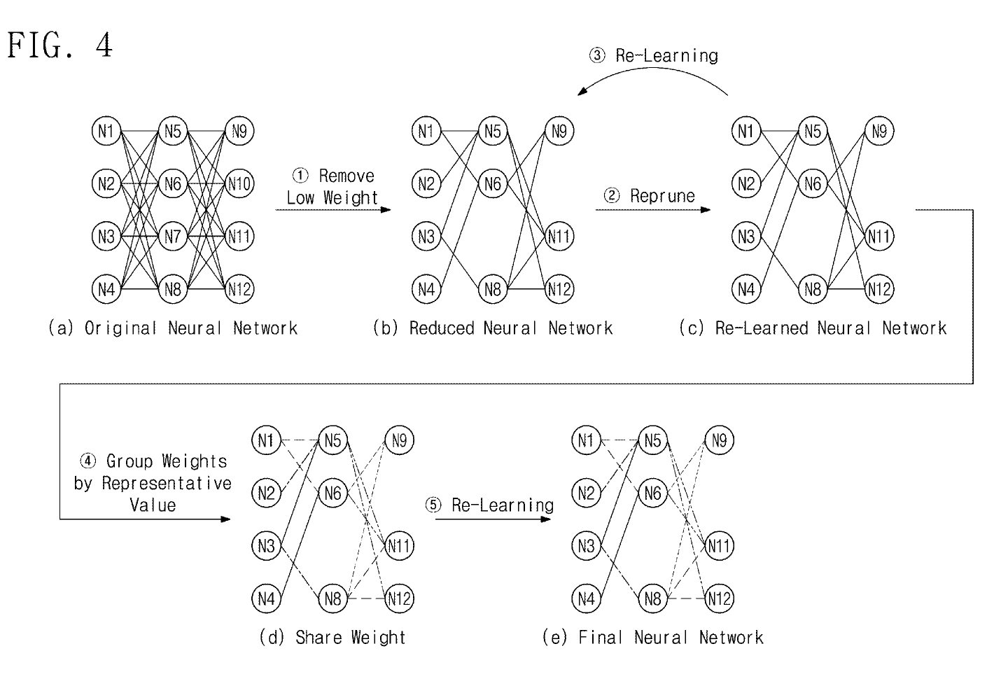

FIG. 4 is a view schematically showing a method of reducing the parameters of the neural network of the inventive concept described with reference to FIG. 3. Referring to FIG. 4, the CNN system 100 (see FIG. 1) of the inventive concept may configure a neural network in which the number of parameters is drastically reduced by performing an adaptive parameter removal technique and an adaptive representative weight sharing technique.

(a) shows an original neural network before removing a weight and applying sharing. That is, neural network learning should proceed first in a state where all nodes of the neural network are present. The original neural network shows the connection relationship of each of the 12 nodes N1 to N16, for example. Between the nodes N1 to N4 and the nodes N5 to N8, there are connections represented by four weights for each node. In the same manner, between the nodes N5 to N8 and the nodes N9 to N12, a neural network may be configured to have connections represented by four weights for each node. Weights between nodes of such an original neural network will be generated with learned parameters. The distribution of parameters learned in this state is known to have a form similar to a normal distribution.

An adaptive parameter removal technique for removing a low weight parameter for the original neural network of (a) will be applied. This procedure is shown in the identification number \textcircled{1}. The adaptive parameter removal technique used in the inventive concept as the low weight removal technique is as follows. That is, an initial threshold value is generated for each layer. Then, iterative learning is performed starting from the generated initial threshold value. Weights higher than the initial threshold value for each layer before learning become lower than the initial threshold value after learning. At this time, the parameter learned with a weight lower than the initial threshold value is removed. Learning is repeated while the connection between once-removed nodes is not restored. The reduced neural network of (b) generated through iterative learning having such an initial threshold value applied will be generated.

As the iteration of learning progresses, the moments when the weights of connections between nodes no longer drop below the initial threshold value occur. At this time, if learning is repeated by applying an upward threshold value higher than the initial threshold value in order to increase the neural network compression efficiency, only nodes and weights necessary for the neural network remain. Once the changed threshold value is determined, a reprune will be performed to further reduce the neural network. This process removes weights with low values while repeating \textcircled{2} re-learning and \textcircled{3} reprune loops.

After removing the low weight parameters using the threshold value, the adaptive weight sharing technique using the representative value is applied. That is, the weight sharing technique is applied to the nodes and weights remaining after the parameter removal technique is applied. In the CNN, a characteristic of weight sharing exist. By using these characteristics, it is possible to group and manage parameters similar or identical to representative values for nodes and weights reduced by the adaptive parameter removal technique. As an example of sharing a weight, if the weight between the nodes N1 and N5 is similar to the weight of the nodes N1 and N6, these connections may be mapped using the weight of one representative value. In addition, if the weight between the nodes N6 and N9 is similar to the weight of the nodes N9 and N9, these connections may be mapped using the weight of one representative value.

The form of the neural network to which the above-described adaptive weight sharing technique is applied is shown in (d). Then, if the neural network generated by the adaptive weight sharing technique is processed through \textcircled{5} the re-learning process, the final neural network of (e) may be configured. Consequently, after applying the adaptive parameter removal technique, the nodes N7 and N10 and the weights related to the nodes N7, N10 may all be removed.

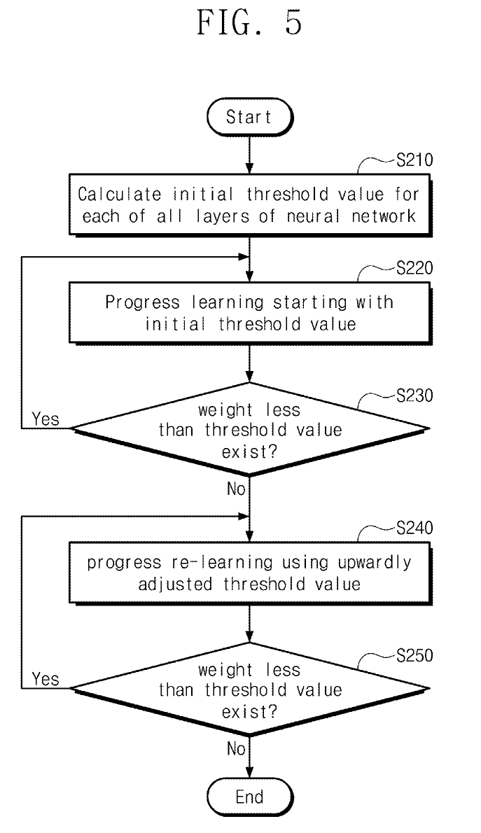

FIG. 5 is a flowchart briefly showing an adaptive parameter removal technique according to an embodiment of the inventive concept. Referring to FIG. 5, low-weight parameters of a neural network may be removed by repeating the learning process accompanied with the setting and adjusting of the threshold value. Only the necessary parameters that determine the characteristics of the neural network may remain by the adaptive parameter removal technique. The weights for all nodes are provided to an existing original neural network by the initial learning.

In operation S210, an initial threshold value is calculated for every layer of the original neural network. In the neural network, the importance of each layer is different. For example, it is very important that the earliest feature point is extracted from the first convolution layer of an input image. In addition, the last convolution layer is important because the probability for a feature value is calculated. The removal of parameters for relatively important layers should be cautious. Therefore, prior to removing the parameters of the important layers, it is necessary to investigate the sensitivity to these layers.

Each layer in the neural network should examine the sensitivity while adjusting the threshold value to remove the weight while the remaining layers remain as they are. For example, in order to calculate the initial threshold value of the first convolution layer, the accuracy is calculated according to the removal ratio by increasing the threshold value slightly while maintaining the inter-node connection of the remaining layers. If the threshold value is slightly increased, there is a section where the accuracy is greatly deteriorated suddenly, and the threshold value at this time is determined as the initial threshold value of the first layer. For the remaining layers, the initial threshold value is obtained by calculating the threshold value in various ways.

In operation S220, iterative learning is performed starting from the initial threshold value determined in operation S210. First, in the weights of each layer of the neural network, a weight higher than the threshold value may be lowered below the threshold value according to the progress of learning. In addition, there will be those with weights lower than the determined initial threshold value in the connections of the original neural network. Parameters with a weight lower than such an initial threshold value are removed at this operation. Herein, the connection between nodes once removed is not restored, and learning proceeds as it is removed. If the parameter is continuously removed through iterative learning, no parameter lower than the threshold value is generated at some point.

In operation S230, it is detected whether there is a weight lower than the initial threshold among the weights between nodes generated as a result of the learning process. If no weight lower than the initial threshold value is detected using a result of the learning process (No direction), the procedure moves to operation S240. On the other hand, if it is detected that there is a weight lower than the initial threshold value (Yes direction), the procedure returns to operation S220, and additional learning and weight removal procedures will proceed.

In operation S240, if there is no weight lower than the initial threshold value, an upward adjustment of the threshold value is performed to increase the compression efficiency. When the threshold value is increased, the standard deviation of a parameter is calculated for each layer. Then, the standard deviation of the calculated layer-specific parameters is multiplied by a predetermined ratio and reflected when the threshold value is raised. When the threshold value is changed, re-learning using an increased threshold value applied is performed.

In operation S250, it will be detected whether or not there is a weight below an increased threshold value for each layer among the parameters of the learned neural network. If no weight lower than the increased initial threshold value is detected among the parameters of the neural network (No direction), the entire procedure of the adaptive parameter removal technique is terminated. On the other hand, if it is detected still that there is a weight lower than the increased threshold value (Yes direction), the procedure returns to operation S240, and additional learning and weight removal procedures will proceed.

As described above, if learning and parameter removal are repeated while varying the threshold value, the parameters with a low weight are removed naturally and only the parameters necessary for the neural network finally remain. When the adaptive parameter removal technique is used, the original neural networks are already learned parameters. Therefore, the adjustment of the threshold value may be performed in small step value units. The distribution of the parameter of a corresponding layer is very important in the process of obtaining such a step value.

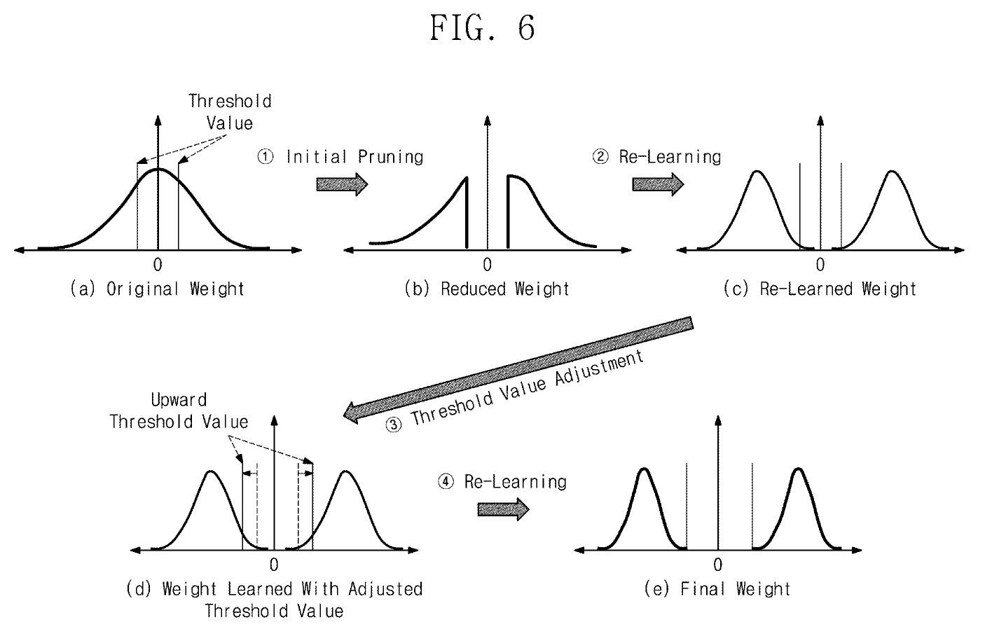

FIG. 6 is a view showing a probability distribution for each operation of parameters when the adaptive parameter removal technique of FIG. 5 is applied. Referring to FIG. 6, in relation to the weights of the neural network, only the parameters higher the threshold value will remain by the adaptive parameter removal technique of the inventive concept.

(a) shows the probability distribution of the original weight and the initial threshold value. The original weight is the weight of the original neural network where all the nodes exist after the learning process. These weights generated by learning form a normal distribution based on an average, i.e., 0. In addition, it may be seen that weights having a value lower than the initial threshold value occupy the majority of all the parameters.

(b) shows the probability distribution of the parameters in the case of removing weights having a value lower than the initial threshold value. That is, by pruning using the initial threshold value, the parameters included in the positive and negative sections of the initial threshold values are removed based on an average.

(c) shows the distribution of weights generated using a result of performing additional learning after removing parameters having a weight lower than the initial threshold value. By re-learning, the sharp distribution at the initial threshold is changed to a soft distribution. However, as a result of re-learning, there are parameters having a weight lower than the initial threshold value. It will be understood that these parameters may be removed through repetition of pruning and re-learning loops.

(d) shows the process of deleting low weight parameters using the adjusted threshold value. That is, if the increased threshold value higher than the initial threshold value is calculated and the re-learning operation of \textcircled{4} is performed, the final weight distribution of (e) is obtained.

Of all the parameters (especially weight), there are low-level weights that do not significantly affect the neural network operation. In the probability distribution, these low weight parameters occupy a relatively large number, and these low weight parameters serve as the burden of the convolution operation, the activation, and the pooling operation. According to the adaptive parameter removal technique of the inventive concept, these low weight parameters may be removed at a level that has little effect on the performance of the neural network.

FIG. 7 is a view showing an adaptive weight sharing technique according to an embodiment of the inventive concept. Referring to FIG. 7, according to the adaptive representative weight sharing technique, similar parameters in each layer in a neural network are mapped and shared as parameters having a single representative value.

When parameters having a low weight are removed according to the adaptive parameter removal technique, weights distributed in each layer have a bimodal distribution. The bimodal distribution is divided into a negative area and a positive area. At this time, the representative value is determined by evenly distributing the lowest value to the highest value in each area. This representative value is called centroid. The weights of the bimodal distribution and an exemplary centroid distribution of each area are shown in the graph below the drawing.

The centroid value for each area is determined by the total number of set representative values. If N centroid values are used, N/2 centroid values will be used for negative bands and N/2 centroid values will be used for positive bands. Each of the initial centroid values is linearly arranged to have an even difference value. In the shown graph, four centroids (−3.5, −2.5, −1.5, and −0.5) are allocated in the negative band, and four centroids (0.5, 1.5, 2.5, and 3.5) are allocated in the positive band.

According to the centroid setting described above, the weights of the exemplary real weight set 320 are approximated based on the centroid value. That is, the real weights are approximated to the centroid value 345, and after approximation, they may be mapped to the centroid index 340. Through the approximation to this representative value, the real weight set 320 may be transformed into an index map 360. The linearly arranged initial centroid values are refined through a re-learning process.

When the centroid value is used in a deep learning recognition engine, a mapping table of the centroid index 340 and the centroid value may be used. If the centroid mapping table of a corresponding layer is read and stored in the recognition hardware engine before the recognition operation is performed, then, only the index value may be read from the memory and processed.

The method using a centroid is described as an example of the adaptive representative weight sharing method. However, it will be understood that the adaptive representative weight sharing method of the inventive concept is not limited to this and that representative values may be mapped and shared in various ways.

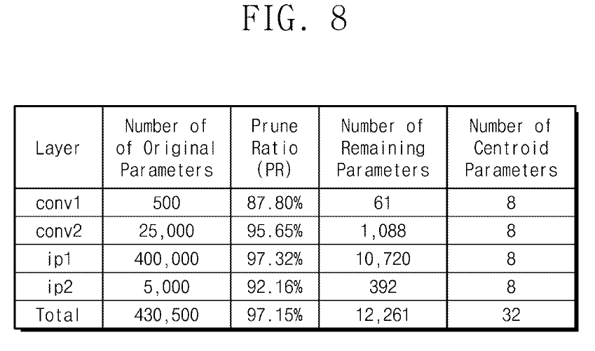

FIG. 8 is a table showing an example of the effect of the inventive concept. Referring to FIG. 8, it shows results when the parameters of the neural network (e.g., LeNet network) shown in FIG. 2 are reduced without accuracy decrease.

By using the adaptive parameter removal technique, it is confirmed that the weight portion of the parameters may be reduced from a total of 430,500 to 12,261. This means that a handwritten number recognition is possible without using 97.15% of the total weight and using only 2.85% of the weight, without affecting accuracy. In addition, by using the adaptive representative weight sharing technique, it may be seen that there are no problems in number recognition even if only eight centroid parameters are used for each layer in the LeNet neural network. The total number of weights actually used is only 32. Therefore, when 12,261 parameters are stored in a memory, they are stored as an index value indicating a representative weight rather than a weight value.

By using the adaptive parameter removal technique and the adaptive representative weight sharing technique, the size of the memory for driving the neural network may be drastically reduced. In addition, the memory bandwidth requirement is greatly reduced due to the reduction of the parameters stored in the memory. In addition, power required for a convolution operation, a pooling operation, and an activation operation is expected to be drastically reduced due to the decrease in the number of parameters.

As described above, the inventive concept proposes a parameter compression method for reducing the amount of operation, which is the biggest issue in hardware implementation of a neural network. When the adaptive parameter removal technique and the adaptive representative weight sharing technique of the inventive concept are used, it is possible to implement an output having the same recognition ratio without using the attenuation effect of recognition accuracy using relatively few parameters. Further, according to the compression method of the inventive concept, the parameter size may be compressed hundreds of times or more from hundreds of megabytes to several megabytes. Therefore, it is possible to recognize objects using a deep learning network even in a mobile terminal. This feature is also a very favorable feature in terms of energy management.

According to embodiments of the inventive concept, the neural network system of the inventive concept may provide an output with the same recognition ratio without the attenuation effect of recognition accuracy using few parameters. In addition, the neural network system using the adaptive parameter removal technique and the adaptive representative weight sharing technique according to the inventive concept may use parameters in a compressed size of several hundred times or more, thereby enabling object recognition using a deep learning network even in a mobile terminal. In addition, the neural network system of the inventive concept is very advantageous in terms of energy consumed per recognition, thereby drastically reducing the power required for driving the CNN system.

Although the exemplary embodiments of the inventive concept have been described, it is understood that the inventive concept should not be limited to these exemplary embodiments but various changes and modifications can be made by one ordinary skilled in the art within the spirit and scope of the inventive concept as hereinafter claimed.

What is claimed is:

1. A method for operating a convolutional neural network, the method comprising:
performing learning on weights between neural network nodes by using input data;
removing an adaptive parameter that performs learning using the input data after removing a weight having a size less than a threshold value among weights; and
mapping remaining weights in the removing of the adaptive parameter to a plurality of representative values.

2. The method of claim 1, wherein in the performing of the learning, the learning is performed in a state including all nodes of the neural network and weights that learn connections between all the nodes are generated.

3. The method of claim 1, wherein the removing of the adaptive parameter comprises:
determining an initial threshold value for each of all layers of the neural network;
removing a weight using the initial threshold value and performing learning; and
removing a weight using an upper threshold value having a value greater than the initial threshold value and performing learning.

4. The method of claim 3, wherein in the determining of the initial threshold value, an initial threshold value of each of all the layers is applied by sequentially varying a threshold value adjusted in a state maintaining a connection of other layers, and a threshold value becoming lower than a standard accuracy is determined as the initial threshold value of each of the layers.

5. The method of claim 3, wherein the removing of the weight using the initial threshold value and the performing of the learning comprise:
removing weights having a size less than the initial threshold value among weights of each of all the layers; and
performing learning on remaining weights where weights having a size less than the initial threshold value are removed.

6. The method of claim 5, wherein the removing of the weights having the size less than the initial threshold value and the performing of the learning on the remaining weights configure an iterative loop and the iterative loop is repeated until the weights having the size less than the initial threshold value are removed.

7. The method of claim 3, wherein the removing of the weight using the upper threshold value having the value greater than the initial threshold value and the performing of the learning comprise:
removing weights having a size less than the upper threshold value among remaining weights; and
performing learning on weights having a size equal to or greater than the upper threshold value.

8. The method of claim 7, wherein the removing of the weights having the size less than the upper threshold value and the performing of the learning on the weights having the size equal to or greater than the upper threshold value configure an iterative loop and the iterative loop is repeated until weights having a size less than the upper threshold value are removed.

9. The method of claim 1, wherein in the sharing of the adaptive weight, a plurality of representative values are determined as a centroid value of the remaining weights.

10. The method of claim 9, wherein the centroid value is redefined through re-learning of the remaining weight.

11. A convolutional neural network system comprises:
an input buffer configured to buffer input data;
an operation unit configured to learn a parameter between a plurality of neural network nodes by using the input data;
an output buffer configured to store and update a learning result of the operation unit;
a parameter buffer configured to deliver a parameter between the plurality of neural network nodes to the operation unit and update the parameter according to a result of the learning; and
a control unit configured to control the parameter buffer to remove weights having a size less than a threshold value among weights between the neural network nodes and map remaining weights among the weights to at least one representative value.

12. The system of claim 11, wherein the control unit performs learning on weights between neural network nodes by using the input data and performs re-learning after removing a weight having a size less than a threshold value among the weights, and maps the remaining weights to a plurality of representative values.

13. The system of claim 12, wherein the control unit determines the threshold value for each of all layers of the neural network.

14. The system of claim 13, wherein the control unit executes a first iterative loop for performing learning by removing weights less than a first threshold value among the weights so as to generate first remaining weights, and
executes a second iterative loop for removing weights less than a second threshold value among the first remaining weights by using the second threshold value greater than the first threshold value so as to generate the remaining weight.

15. The system of claim 14, wherein the representative value corresponds to a centroid.

16. The system of claim 14, wherein the control unit stores a mapping table of a centroid index to which the representative value is mapped and the centroid and exchanges the centroid index as the remaining weight with an external memory.
